(19) United States
(12) Patent Application Publication
(10) Pub. No.: US 2001/0049670 A1
(43) Pub. Date: Dec. 6, 2001

(54) Invention interview process

(76) Inventor: John E. Cronin, Milton, VT (US)

Correspondence Address: Ryan Simmous, ip Capital Group, Inc, Suite 325, 400 Cornerstone Drive, Williston, VT, 05495, US

(21) Appl. No.: 09/781,361

(22) Filed: Feb. 12, 2001

Related U.S. Application Data
(60) Provisional application No. 60/181,741, filed on Feb. 11, 2000.
(60) Provisional application No. 60/181,459, filed on Feb. 10, 2000.
(60) Provisional application No. 60/179,675, filed on Feb. 2, 2000.
(60) Provisional application No. 60/181,816, filed on Feb. 11, 2000.
(60) Provisional application No. 60/181,825, filed on Feb. 11, 2000.

(51) Int. Cl. G06F 15/18

(52) U.S. Cl. 706/12

(57) ABSTRACT

In general, in one aspect, the invention features a method of facilitating conception of inventive concepts by an inventor, preferably including the following steps. First, interviewing an inventor to identify or otherwise characterize a basic invention. Second, facilitating conception of inventive elements using creative stimulus comprising how-type questions relating to the functioning of the invention identified in the first step. Third repeating the second and third steps.

### 1. CROSS-REFERENCE TO RELATED APPLICATIONS

This application claims the benefit of, and expressly incorporates herein by reference, the entire disclosures of the following U.S. Patent Applications:

U.S. patent application Ser. No. ______ (ipCG-507), entitled SYSTEM AND METHOD FOR FACILITATING THE CONCEPTION OF INVENTIONS IN A DIRECTED MANNER, filed Feb. 12, 2001, which in turn claims priority to U.S. patent application Ser. No. 60/181,459, entitled PROCESS FOR FACILITATING THE CONCEPTION OF INVENTIONS IN A DIRECTED MANNER, filed Feb. 10, 2000;

U.S. patent application Ser. No. ______ (ipCG-508), entitled NETWORK BASED SYSTEM AND METHOD FOR FACILITATING THE CONCEPTION OF INVENTIONS IN A DIRECTED MANNER, filed Feb. 12, 2001, which in turn claims priority to U.S. patent application Ser. No. 60/181,816, entitled WEB-BASED PROCESS FOR FACILITATING THE CONCEPTION OF INVENTIONS IN A DIRECTED MANNER, filed Feb. 11, 2000;

U.S. patent application Ser. No. ______ (ipCG-509), entitled INVENTION INTERVIEW PROCESS, filed Feb. 12, 2001, which in turn claims priority to U.S. patent application Ser No. 60/181,741, entitled INVENTION INTERVIEW PROCESS, filed Feb. 11, 2000;

U.S. patent application Ser. No. (ipCG-519), entitled AUTOMATED IP TRACKING SYSTEM AND METHOD, filed Feb. 12, 2001, which in turn claims priority to U.S. patent application Ser. No. 60/181,741, entitled AUTOMATED IP PROCESS FOR TRACKING IP MATTERS, filed Feb. 11, 2000;

U.S. patent application Ser. No. (ipCG-506), entitled SCANNING INVENTION PROCESS, filed on Jan. 19, 2001, which in turn claims priority to U.S. patent application No. 60/179,675, entitled SCANNING INVENTION PROCESS, filed Jan. 19, 2001.

### 2. FIELD OF THE INVENTION

The invention relates to a novel interview process for eliciting disclosure and/or conception of inventive information from an individual or group, enhancing an invention through structured interview techniques, and documenting the output of the invention interview in order to accurately and comprehensively define the potential intellectual property space occupied by the invention covers, and to facilitate the creation of an invention disclosure document, provisional patent application, or utility patent application.

### 3. BACKGROUND OF THE INVENTION

Art relating to the background of the invention is discussed in the ensuing subsections.

3.1 Invention as a Creative Process

One way in which humans are distinguished from other animals is the degree of human inventiveness. The earliest human archeological sites are characterized by the presence of tools invented by humans. The advent of recorded history is the direct result of human invention, and that history is largely a history of human invention, as seen in the advance of science and technology and corresponding changes in human social, organizational and political structures. Today, the inventive process is the source of an unprecedented pace of technological development, which characterizes the ever-changing modern world.

Given the historical and cultural importance of invention, many researchers have investigated the mental processes associated with inventing. For example, Colangelo et al. investigated mechanical inventiveness (i.e., the conception and development of new devices which require use of mechanical principles) to identify psychological characteristics shared by successful inventors (Ciba Identified. Symp. 1993, 178:160-70). Other researchers have focused on the creative aspects of groups. Still others have investigated the effects of social or organizational structures on inventiveness. Lamoreaux et al., for example, investigated the effects of economic changes on the rate of invention and concluded that high rates of inventive activity encourage the evolution of a market for technology, which in turn encourages greater specialization and inventive productivity as individuals find it increasingly feasible to sell and license their discoveries (Proc Natl Acad Sci U.S.A. 1996; 93(23): 12686-92).

3.2 Invention Process as a Legal Property Process

Most countries of the world have established legal schemes to govern the patenting of inventions. Patent laws are typically administered by a centralized patent office, and only licensed patent attorneys and/or agents are legally permitted to practice patent law.

In the United States, the patent system is based on Article I of the U.S. Constitution and consists an enormous body of statutory law, case law, regulations and procedures, administered by the U.S. Patent and Trademark Office (USPTO). Although individual inventors may represent themselves before the USPTO, only registered patent attorneys and patent agents may represent others. Patent attorneys and agents must qualify for registration by passing a federally administered exam. The exam requires prospective patent attorneys and agents to demonstrate a detailed knowledge of patent law and procedure. However, while patent attorneys and agents are experts in patent law, they typically have no formal training in the art of inventing or in techniques for working with inventors or others to facilitate invention.

3.3 Invention Software Tools for Extracting Details of an Invention

Software tools are currently available for use by attorneys and inventors to document inventions. For example, the PatentPro™ software system is stated to “walk the user through the patent application process with ease and at a fraction of the cost of hiring a patent attorney.” See www./patpro.com/press041300.htm. After the user has completed all steps, the software is asserted to produce a properly formatted patent application suitable for submision to the USPTO. However, presently available systems do not facilitate invention, nor do they facilitate expansion of an invention concept.

### 4. SUMMARY OF THE INVENTION

In general, in one aspect, the invention features a method of facilitating conception of inventive concepts by an inventor, preferably including the following steps. First, interviewing an inventor to identify or otherwise characterize a basic invention. Second, facilitating conception of inventive elements using creative stimulus comprising how-type questions relating to the functioning of the invention identified in the first step. Third repeating the second and third steps.

Implementations of the invention may include one or more of the following. The basic invention is preferably identified and/or characterized by accomplishing any one or more of the following. First, facilitating drawing of a diagram of the basic invention. Second, facilitating definition of one or more elements of the basic invention. Third, facilitating definitions of problem(s) solved and/or problems to be solved by the basic invention.

Concepts are preferably communicated to the inventors and the concepts may include the following: concept of an invention being a function of the problem to be solved by the basic invention, the element(s) that comprise the basic invention, and how the elements are connected or interrelated; a ladder of abstraction; prior art, novelty, nonobviousness, inventive step, and bar dates; inventorship; enablement and written description; and concept of prior art.

The basic invention may be grown using the following. First, identifying the basic invention. Second, selecting a questioning theme. Third, identifying an aspect of the basic invention by one or more inventors that falls within the questioning theme. Fourth, identifying enhancements to the basic invention by the one or more inventors, wherein the enhancements relate to the aspect of the invention. Fifth, repeating the third and fourth steps one or more times for alternate aspects of the basic invention within a questioning theme. Sixth, repeating the second through fifth steps one or more times for alternate questioning themes. The alternate questioning themes may be selected from one or more of the following: disadvantages of the basic invention; advantages of the basic invention; operability issue(s); other ways to solve a same problem; licensing strategies; and identification of competitors and/or competitive products.

Prior to the “growing” of the basic invention, preferably communicating to the inventor(s) any one or more of the following concepts: concept of an invention being a function of a problem to be solved by the basic invention, element(s) that comprise the basic invention, and how the element(s) are connected or interrelated; a ladder of abstraction; prior art, novelty, nonobviousness, inventive step, and bar dates; inventorship; and enablement and written description.

The output of any of the above steps and/or administrative information may be documented and/or recorded.

In general, in a second aspect, the invention features a method of facilitating conception of inventive concepts by an inventor and may include one or more of the following steps. First, communicating to the inventors concepts selected from the following group: concept of an invention being a function of a problem to be solved by the basic invention, element(s) that comprise the basic invention, and how the element(s) are connected or interrelated; a ladder of abstraction; prior art, novelty, nonobviousness, inventive step, and bar dates; inventorship; and enablement and written description. Second, defining detail of the basic invention the defining detail of the basic invention may include one or more of the following: first, interviewing an inventor to identify or otherwise characterize a basic invention; second, facilitating conception of inventive elements using creative stimulus comprising how-type questions relating to the functioning of the invention identified in the first step; and third repeating the first and second steps. Third, growing the basic invention by one or more of the following steps: first, identifying the basic invention; second, selecting a questioning theme; third, identifying an aspect of the basic invention that falls within the questioning theme; fourth, identifying enhancements to the basic invention by the inventor(s), wherein the enhancements relate to the aspect of the invention; fifth, repeating the third and fourth steps one or more times for alternate aspects of the basic invention a questioning theme; and repeating the second through fifth steps one or more times for alternate questioning themes. Fourth, documenting and/or recording the output of any of steps above. Fifth, documenting and/or recording the administrative information.

The alternate questioning themes may include one or more themes from the following group: disadvantages of the basic invention; advantages of the basic invention; operability issues; other ways to solve a same problem; licensing strategies; and identification of competitors and/or competitive products.

5. Definitions

As used herein, the term “invention” means conceptual subject matter pertaining to (1) a useful product or process not previously known to the person(s) conceiving of the invention; or (2) a new use for an existing product or process, which use was not previously known to the person(s) conceiving of the invention. The term “invention” includes both patentable and non-patentable subject matter. It is noted that patentability is based on legal standards, which vary with changes in law; furthermore, patentability is premised on a legal analysis of the precise words of a patent claim and not on the degree of novelty, utility, enablement, etc. of an inventive concept in general. The term “inventor,” is used herein to refer to one who has solely or jointly conceived of an invention.

Unless specifically indicated, legal terms of art used herein (e.g., product, process, novel, nonobvious, utility, enable and the like) should be understood in their broadest sense, as encompassing not only strict legal definitions, but also encompassing ordinary meaning that would be attributed to the terms by one with no specialized knowledge of patent law.

### 6. BRIEF DESCRIPTION OF THE DRAWINGS

FIG. 1 illustrates the overall process of the invention for taking raw ideas and generating a written invention disclosure or patent application.

FIG. 2 is a schematic diagram of a marker invention, illustrating the process of the invention.

FIG. 3 is an illustration of the use of the “Ladder of Abstraction”, using the marker invention of FIG. 2 to illustrate the method of the invention using variously defined points that demonstrate the “level” of an invention.

### 7. DETAILED DESCRIPTION OF THE INVENTION

The invention generally relates to a method for interviewing one or more inventors to identify information relating to an invention, enhancing the invention through a structured interview, and documenting the output of the invention interview in a systematic way to accurately and comprehensively define the potential intellectual property space that the invention covers. The method of the invention also facilitates the creation of an invention disclosure document, provisional patent application, or utility patent application.

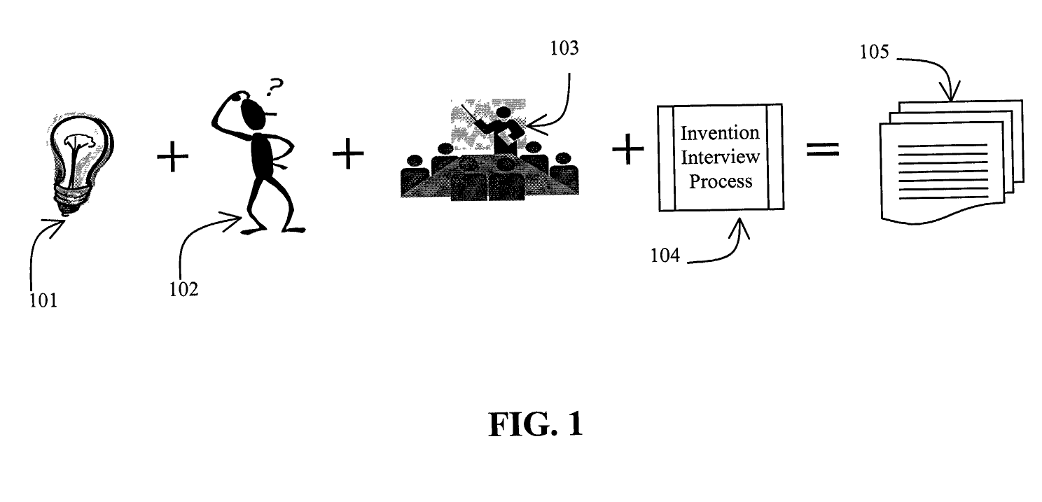

FIG. 1 illustrates the overall process of the invention. An idea 101 is presented to and/or conceived by an inventor 102. A facilitator 103 conducts a session according to the novel interview process 104 of the invention to elicit further ideas relating to the invention. This session results in the generation and collection of information, which is documented in an invention interview form 105 or other document.

In the method of the invention, the initial inventive idea 101 does not need to be enabled (i.e., it is not necessary for one of skill in the art to be able to make and use the invention); however, the method of the invention is useful, even where the invention is fully enabled and/or actually reduced to practice. For example, the method of the invention is particularly useful where the idea an enabled invention has not been recorded in a descriptive document suitable to facilitate a patentability by a patent agent and/or patent attorney. Moreover, the method of the invention is also useful in circumstances in which an enabled invention has never been examined for possible improvements or alternative uses.

The facilitator 103 is one who is trained to execute the invention interview process of the invention. The facilitator 103 guides the inventor(s) 102 through the invention interview process. It is not necessary for the facilitator 103 to be knowledgeable in the technology field of the invention. Where an inventor is trained in the method of the invention, he or she can serve as both the facilitator and the inventor. In other words, such an individual can use the method document and expand the scope of his or her own invention, and no “interview” is necessary. Thus, for example, written materials or a computer program, which trains an inventor in the method of the invention is within the scope of the invention.

The invention interview form 105 or document is preferably completed by the facilitator 103 during the invention interview process. However, the form or document may be completed by one other than in facilitator 103, either during or after the interview process. The interview is preferably recorded (e.g., sound and/or audio recording) to facilitate completion of the form 105 or document after the interview process.

The completed form or disclosure document will generally include a textual description of the invention and may also contain drawings, schematics, flowcharts, photographs, software source code, and/or other information. The form or disclosure document may be completed manually, or with the use of a computer. Where a computer is used, input may be by any of a variety of available input means, such as keyboard, mouse, digital pen, sound recording, and the like. Voice-to-text and handwriting-converting software may be useful in the process of inputting such information.

The interview process of the invention generally comprises any one or more of the following steps:

1. training inventors on the inventive process and on legal, business, and/or scientific concepts regarding the definition of an invention;

2. systematic questioning of the inventor(s) to understand and enhance the invention;

3. “growing” the invention;

4. documenting the output of steps 1-3 in a standardized invention interview form (optionally including visually or audially recording the execution of steps 1-3); and

5. capturing administrative information.

Preferably steps 1-4 are used, more preferably steps 1-5 are used. The steps may be performed in any logical order. Each step is discussed in the ensuing subsections 6.1-6.5.

7.1 Training of Inventors

Step 1 involves communicating information to the inventors relating to the inventive process and legal, business, and/or scientific concepts regarding the definition of an invention. The inventors are preferably trained to recognize one or more basic legal concepts relating to patentability. Examples of concepts in which the inventors are trained include: utility, enablement, written description, novelty, nonobviousness, inventive step, etc. It will be understood that where legal concepts are involved, the subject matter of the training will vary to conform with changes in the law, and will vary from country-to-country, to account for differences in legal systems governing patenting of inventions.

In a preferred embodiment of the invention, the inventor(s) are trained in one or more of the following concepts:

invention as a function of the problem to be solved, the elements that comprise the invention, and how the elements are connected or related

the ladder of abstraction creativity tool

novelty, nonobviousness, inventive step, prior art and the like, and the relationship of these concepts to bar dates

legal and/or business concepts relating to inventorship

legal and/or business concepts relating to enablement

The training of inventors is preferably accomplished directly by a facilitator. The facilitator may be present with the inventor(s) or physically and/or geographically separated from the inventor(s). Various means of communication may be used, such as visual, audio, and/or textual telecommunications, internet communications, etc. Moreover, the training may be accomplished without need for the facilitator, e.g., by video or audio presentation, use of a website, use of a computer program, use of textual materials, and the like.

7.2 Systematic Questioning of Inventor(s)

The interview process generally involves a facilitator (a trained individual who understands the interview process) and an inventor. The interviewing session involves systematically questioning the inventor to elicit information from the inventor. Information elicited preferably includes information relating to problems solved by the invention; solutions to such problems; enabling concepts relating to the components, design, steps, principles of operation and the like; and information relating to alternative embodiments.

7.2.1 Understanding the Problem Solved by the Invention

In general, the interview method of the invention comprises a step in which the facilitator elicits information from the inventor relating to the basic problem solved by the invention, the elements of the invention and the operational relationship between the elements. In a preferred embodiment, this information is elicited using the following substeps: drawing a picture of the invention; defining the elements of the picture; and defining the problem(s) solved or to be solved.

The method of the invention also preferably includes a step in which the facilitator facilitates conception by the inventor of additional details or alternative embodiments of the invention. This step is suitably accomplished using the following substeps: using the ladder of abstraction method to define a problem to be solved; understand the elements and how of the ladder of abstraction; and iterating the first two substeps to understand the invention between the business level and the science level.

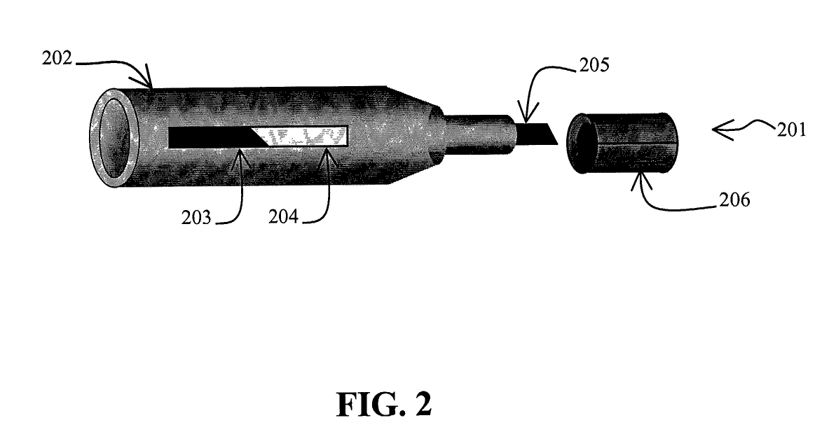

By way of example, FIG. 2 represents a drawing of a fictional dry erase marker invention. The inventor of the dry erase marker has created the drawing in FIG. 2 during the invention interview session in response to a question by the facilitator, such as “Can you draw me a picture of your invention and label each of the elements?” FIG. 2 shows the marker 201 with the marker body 202, ink level 203, clear plastic window 204, felt marker tip 205, and marker cap 206. In response to the facilitator's question “What problem are you trying to solve?” the inventor indicates that the problem solved by the invention can be stated as “How to see the level of ink in the marker.” Hence, the reason for the basic invention, which is the addition of the clear plastic window 204 to the dry erase marker body 202, is now understood.

7.2.2 Facilitating Additional Conception: Up the Ladder of Abstraction

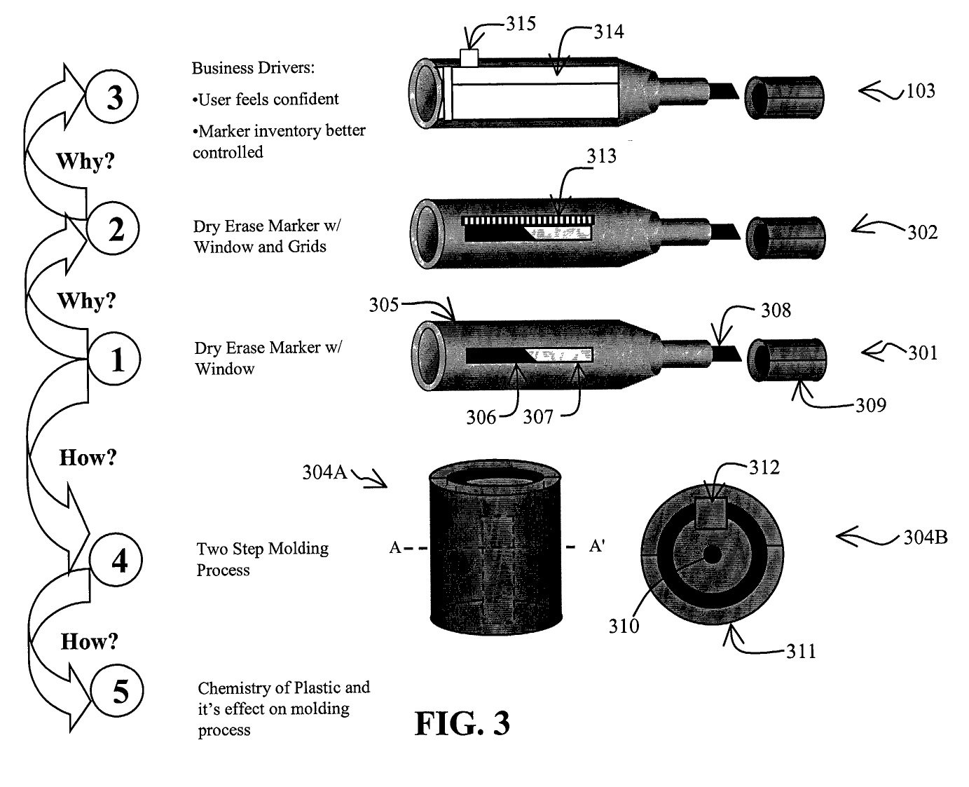

Next, the facilitator facilitates further conception by the inventor, preferably by employing a creativity tool, such as the “ladder of abstraction” tool. In this aspect of the invention, the inventor asks a series of questions, preferably in the form of “why” questions, such as “Why is the window important?” Use of the “ladder of abstraction” tool is illustrated by FIG. 3.

Points 1, 2, 3, 4 and 5 are encircled in FIG. 3. Point 1 represents the starting point in this aspect of the invention. Point 1 shows a brief description of marker 201, representing the concept of the invention as it has been established upon completion of the method described in Section 6.2.1. The ink level in the dry erase marker can be viewed through a clear plastic window 307 along the side of the marker body 301.

The question “Why is point 1 important?” elicits an answer, point 2, which is an additional or alternative concept as compared to the concept identified at point 1. The inventor explains that a user has no way of knowing when the ink in the marker is depleted until the marker is being used in a presentation. This statement of the reason for the invention leads to the discovery of a new problem to be solved: how to measure the amount of ink in the marker. The identification of this problem leads to a further improvement to the basic invention. The clear plastic window 307 along the side of the dry erase marker body 305 may have a scale 312 that indicates the amount of ink remaining in the marker 302.

Similarly, the question “Why is point 2 important?” results in the observation by the inventor that the user needs to avoid running out of fluid during a presentation. This observation points to a problem: how to prevent ink from running out. The identification of the problem leads to a solution: a secondary ink fluid reserve tank that allows a fixed short amount of writing time and shown as point 3 uses a penetrable ink bladder 313 activated by pressing a button 314 on the dry erase marker body.

An inventor discussing his or her invention usually describes the invention in terms of the technical problem solved by the invention. Asking a series of “why” questions elicits production and conception of higher levels of integration. New problems to be solved are identified, solutions to the problems are elicited in the form of enhancements to the original invention or the discovery of other applications for the invention.

Movement up the ladder of abstraction provides a broader set of reasons for the invention, and thereby elicits conception of broader and/or alternative inventions or aspects of the original invention.

In the method of the invention the starting point is preferably a technical reason for an invention, and the series invention-broadening or “why” questions will ultimately lead to a business reason for the invention, which is really a broader interpretation of the original technical reason. For example, the ultimate reasons for inventing a better marker may be to sell more markers, to increase share price, etc.

7.2.3 Enabling the Invention: Down the Ladder of Abstraction

Once the problem solved by the invention has been elucidated, and alternative and/or additional aspects have been produced and or conceived, the facilitator switches gears and facilitates the production and conception of enabling details of the invention. This stage of the method of the invention is characterized by invention-narrowing questions, typically in the form of “how” questions.

Referring again to FIG. 3, asking the question “How is point 1 achieved?” elicits point 4, which is a more detailed explanation of the original invention 301. Point 4 solves a new problem of how to create a window in a plastic cylinder. Point 4 provides a potentially patentable plastic mold 304A/304B and/or molding process comprising an inner solid cylinder 310 and an outer hinged cylinder 311 with a metal insert 313 arranged such that when plastic flows into the space between the inner and outer cylinders, an open region is formed into which a clear plastic window is inserted.

The question “How is point 4 achieved,” yields another problem to be solved, namely “What type of plastic would be best suited to create a clear plastic window?” This may be solved by known plastics molding technologies or may result in further novel developments, such as novel uses of particular plastics or even conception of novel plastics.

If the starting point is a technical reason, then a series of “how” questions ultimately leads to scientific reasons. Thus, using the ladder of abstraction, any starting point can be taken and different “levels of invention” defined.

As noted above, an inventor discussing his or her invention usually describes the invention in terms of the technical problem solved by the invention. Asking a series of “how” questions, facilitates conception of a more detailed description of the critical elements of the invention, especially those relating to the primary embodiment or best mode. These details contribute to enabling the invention. Additional, “how” questions ultimately lead to scientific reasons or principles. Pure scientific principles are not patentable; however, asking “how” questions until pure scientific principles are reached provides an indication that the invention is at a high degree of conceptual development, and that it is therefore potentially patentable, even without actual reduction to practice. An inability to reach established scientific principles can indicate that further research is needed before the invention will be patentable.

7.3 Growing the Invention

The interview method of the invention preferably includes a “growing the invention” step. This step is useful to elicit enhancements to the basic invention through a structured set of questioning themes. Examples of suitable questioning themes include: disadvantages of the invention, advantages of the invention, operability issues, other ways to solve the same problem, licensing strategy, and identification of competitors.

The “growing the invention” component of the interview method generally includes one or more of the following steps:

1. identification and/or characterization of a basic invention;

2. selection of a questioning theme by the facilitator;

3. identification by the inventor of an aspect of the basic invention that falls within the questioning theme chosen;

4. conception, preferably by the inventor, of enhancements to the basic invention relating to the aspect identified in step 3;

5. iteration of steps 3 and 4 for different aspects within the same questioning theme until aspects are exhausted; and

6. iteration of steps 2-5 until questioning themes are exhausted.

As an example, consider the hypothetical marker invention described above and illustrated in FIG. 2. A facilitator executing the “growing the invention” component of the interview method would choose a questioning theme. If, for example, the theme “disadvantages of the basic invention,” is chosen, then the inventor may be asked to identify aspects of the basic invention of FIG. 2 that may be thought of as disadvantages. In this example, the inventor may identify “difficulty in seeing the ink through the small clear plastic window” as being a potential disadvantage. Then based on the identified disadvantage, the inventor can be asked to propose an enhancement to the basic invention addressing the disadvantage. An example of an enhancement to the basic invention addressing this disadvantage would be to shape the clear plastic window so that it functions as a lens, thereby magnifying the view of the ink. This process can be continued, identifying additional disadvantages, until the inventor can conceive of no more aspects within this questioning theme.

Another questioning theme can then be selected, such as “advantages of the basic invention.” The inventor can be asked to identify aspects of the basic invention that may be thought of as advantages. In this example the inventor may identify “advanced notice of ink shortage” as being an advantage of the basic invention. Based on this advantage, the inventor can be asked to propose an enhancement or alternative to the basic invention relating to this advantage. An example of such an enhancement might be to add a miniature radio transmitter to the marker that alerts an inventory monitoring system when the ink in the marker is running low, so that new markers can be ordered.

Another questioning theme can then be selected, such as “operability issues.” The inventor can be asked to identify aspects of the basic invention that may be thought of as operability issues, e.g., an aspect of the invention that might prevent the invention from working. In this example, the inventor may identify “occlusion of the clear plastic window by ink” as an operability issue of the basic invention. The inventor can be asked to propose an enhancement to the basic invention to address the operability issue. Continuing with the marker example, a solution might be to ensure that the clear plastic window is made from a plastic that is resistant to ink or to utilize a lipophilic material for the clear window and a hydrophilic ink.

This process may therefore be continued using multiple questioning themes. The result is a number of potentially patentable enhancements to the basic invention. The questioning theme “other ways to solve the same problem” might result in the inventor revisiting ways that he or she had thought of to solve the problem in the past and yet discarded at the time for erroneous reasons. The last two examples of questioning themes, licensing and competitors, may result in the inventor re-evaluating how the invention fits into the competitive and/or patent landscape.

7.4 Documenting the Invention Interview

The facilitator, using any recording means (e.g., paper and pencil, computer word processing, tape recorder, video recorder) must minimally capture the description of the basic invention and the enhancements and/or alternatives to that basic invention identified during the invention interview process. Additionally, the facilitator may record other information including, but not limited to, known prior art, licensing opportunities, competitors, other ways to solve the same problem, etc.

7.5 Capturing Administrative Information

The facilitator, using any recording means (e.g., paper and pencil, computer word processing, tape recorder, video recorder) preferably captures the administrative information related to the basic invention and all of the enhancements to that basic invention discovered during the invention interview process. Minimally, the facilitator must capture the inventor name(s) and the date of interview. Additionally, the facilitator may record other information, such as, invention title, inventor contact information (e.g. mailing address, phone number, email address), assignee name, etc.

The many features and advantages of the invention are apparent from the detailed specification. Numerous modifications and changes will readily occur to those of ordinary skill in the art; consequently, the invention is not limited to the embodiments described herein. All suitable modifications and equivalents should be considered as falling within the spirit and scope of the invention.

What is claimed is:

1. A method of facilitating conception of inventive concepts by an inventor, the method comprising any one or more of the following:
(a) interviewing an inventor to identify or otherwise characterize a basic invention;
(b) facilitating conception of inventive elements using creative stimulus comprising how-type questions relating to the functioning of the invention identified in l(a); and
(c) iterating (b)(i) to (b)(ii).

2. The method of claim 1 wherein the basic invention is identified and/or characterized by accomplishing any one or more of the following steps:
(a) facilitating drawing of a diagram of the basic invention;
(b) facilitating definition of one or more elements of the basic invention; and
(c) facilitating definition of problem(s) solved and/or problems to be solved by the basic invention.

3. The method of claim 1 further comprising communicating to the inventors any one or more concepts selected from the group consisting of.
(a) concept of an invention being a function of the problem to be solved by the basic invention, the element(s) that comprise the basic invention, and how the elements are connected or interrelated;
(b) a ladder of abstraction;
(c) prior art, novelty, nonobviousness, inventive step, and bar dates;
(d) inventorship; and
(e) enablement and written description.

4. The method of claim 1 further comprising documenting and/or recording output of any of steps (a)-(c).

5. The method of claim 1 further comprising documenting and/or recording administrative information.

6. A method of “growing” a basic invention, the method comprising:
(a) identifying the basic invention;
(b) selecting a questioning theme;
(c) identifying an aspect of the basic invention by one or more inventors that falls within the questioning theme;
(d) identifying enhancements to the basic invention by the one or more inventors, wherein the enhancements relate to the aspect of the invention;
(e) repeating (c)-(d) one or more times for alternate aspects of the basic invention within a questioning theme; and
(f) repeating (b)-(e) one or more times for alternate questioning themes.

7. The method of claim 7 wherein the alternate questioning themes comprises one or more themes selected from the group consisting of:
(a) disadvantages of the basic invention;
(b) advantages of the basic invention;
(c) operability issue(s);
(d) other ways to solve a same problem;
(e) licensing strategies; and
(f) identification of competitors and/or competitive products.

8. The method of claim 7 further comprising prior to the “growing” of the basic invention, communicating to the inventor(s) any one or more concepts selected from the group consisting of:
(a) concept of an invention being a function of a problem to be solved by the basic invention, element(s) that comprise the basic invention, and how the element(s) are connected or interrelated;
(b) a ladder of abstraction;
(c) prior art, novelty, nonobviousness, inventive step, and bar dates;
(d) inventorship; and
(e) enablement and written description.

9. The method of claim 7 further comprising documenting and/or recording output of any of steps (a)-(f).

10. The method of claim 7 further comprising documenting and/or recording administrative information.

11. A method of facilitating conception of inventive concepts by an inventor, the method comprising any one or more of the following:
(a) communicating to the inventors concepts selected from the group consisting of:
(i) concept of an invention being a function of a problem to be solved by the basic invention, element(s) that comprise the basic invention, and how the element(s) are connected or interrelated;
(ii) a ladder of abstraction;
(iii) prior art, novelty, nonobviousness, inventive step, and bar dates;
(iv) inventorship; and
(v) enablement and written description;
(b) defining detail of the basic invention the defining detail of the basic invention comprises any one or more of the following:
(i) interviewing an inventor to identify or otherwise characterize a basic invention;
(ii) facilitating conception of inventive elements using creative stimulus comprising how-type questions relating to the functioning of the invention identified in (b)(i); and
(iii) repeating (b)(i) to (b)(ii);
(c) growing the basic invention by a method comprising any one or more of the following steps:
(i) identifying the basic invention;
(ii) selecting a questioning theme;
(iii) identifying an aspect of the basic invention that falls within the questioning theme;
(iv) identifying enhancements to the basic invention by the inventor(s), wherein the enhancements relate to the aspect of the invention;
(v) repeating (c)(iii)-(c)(iv) one or more times for alternate aspects of the basic invention a questioning theme; and
(vi) repeating (c)(ii)-(c)(v) one or more times for alternate questioning themes;
(d) documenting and/or recording output of any of steps (b)(i)-(b)(iii) and (c)(i)-(c)(vi); and
(e) documenting and/or recording administrative information.

12. The method of claim 13 wherein the alternate questioning themes comprise one or more themes selected from the group consisting of:
(a) disadvantages of the basic invention;
(b) advantages of the basic invention;
(c) operability issues;
(d) other ways to solve a same problem;
(e) licensing strategies; and
(f) identification of competitors and/or competitive products.
